(19) United States
(12) Patent Application Publication
(10) Pub. No.: US 2015/0239717 A1
(43) Pub. Date: Aug. 27, 2015

(54) Wall Mountable Pulley Device

(71) Applicant: John Hayes, Ridgefield Park, NJ (US)

(72) Inventor: John Hayes, Ridgefield Park, NJ (US)

(21) Appl. No.: 14/190,271

(22) Filed: Feb. 26, 2014

(51) Int. Cl. B66D 3/12

(52) U.S. Cl. CPC B66D 3/12

(57) ABSTRACT

A wall mountable pulley device minimizes friction while manually raising or lowering long lengths of rope or cables over the edge of high rise buildings. The device includes a plate having a perimeter edge extending around the plate. A pair of side walls is provided. Each of the side walls is coupled to and extends from the plate. A roller is coupled to and extends between the side walls. A pair of mounts is provided. The mounts are coupled to the plate. The mounts are spaced apart. Each of the mounts is configured for coupling a respective bar clamp to the plate wherein the plate is couplable to a wall by clamping the bar clamps to the wall.

### BACKGROUND OF THE DISCLOSURE

1. Field of the Disclosure

The disclosure relates to pulley devices and more particularly pertains to a new pulley device for minimizing friction while manually raising or lowering long lengths of rope or cables over the edge of high rise buildings.

2. Summary of the Disclosure

An embodiment of the disclosure meets the needs presented above by generally comprising a plate having a perimeter edge extending around the plate. A pair of side walls is provided. Each of the side walls is coupled to and extends from the plate. A roller is coupled to and extends between the side walls. A pair of mounts is provided. The mounts are coupled to the plate. The mounts are spaced apart. Each of the mounts is configured for coupling a respective bar clamp to the plate wherein the plate is couplable to a wall by clamping the bar clamps to the wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a wall mountable pulley device according to an embodiment of the disclosure.

FIG. 2 is a top view of an embodiment of the disclosure.

FIG. 3 is a front view of an embodiment of the disclosure.

FIG. 4 is a side view of an embodiment of the disclosure.

FIG. 5 is a side view of an embodiment of the disclosure in use.

### DESCRIPTION OF THE PREFERRED EMBODIMENT

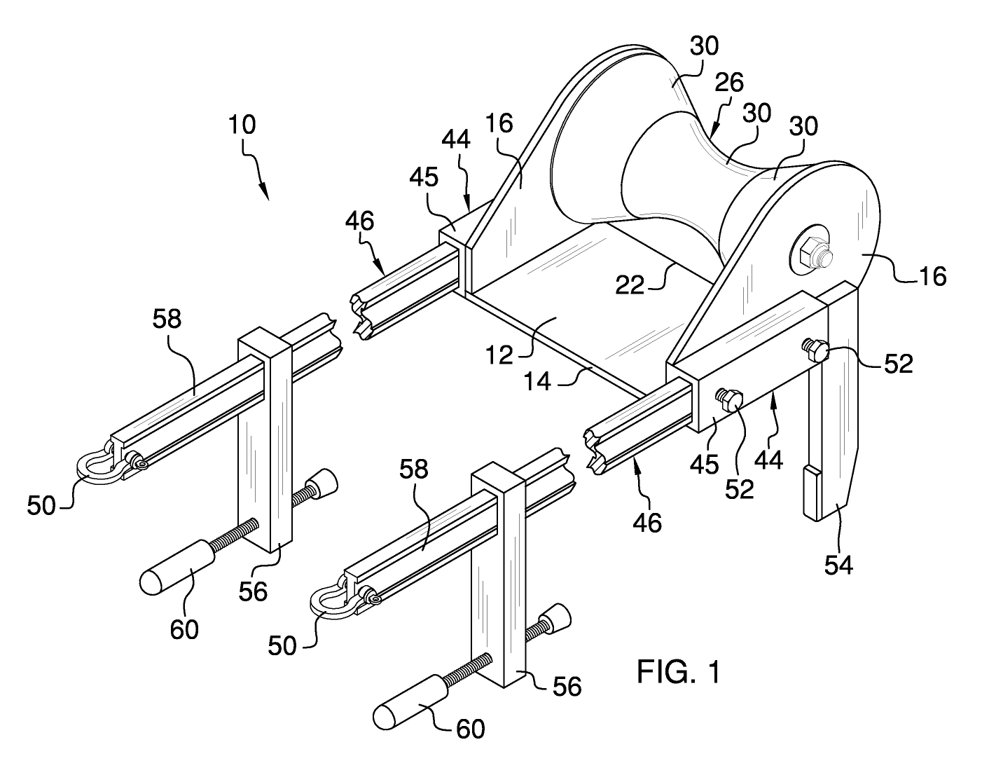

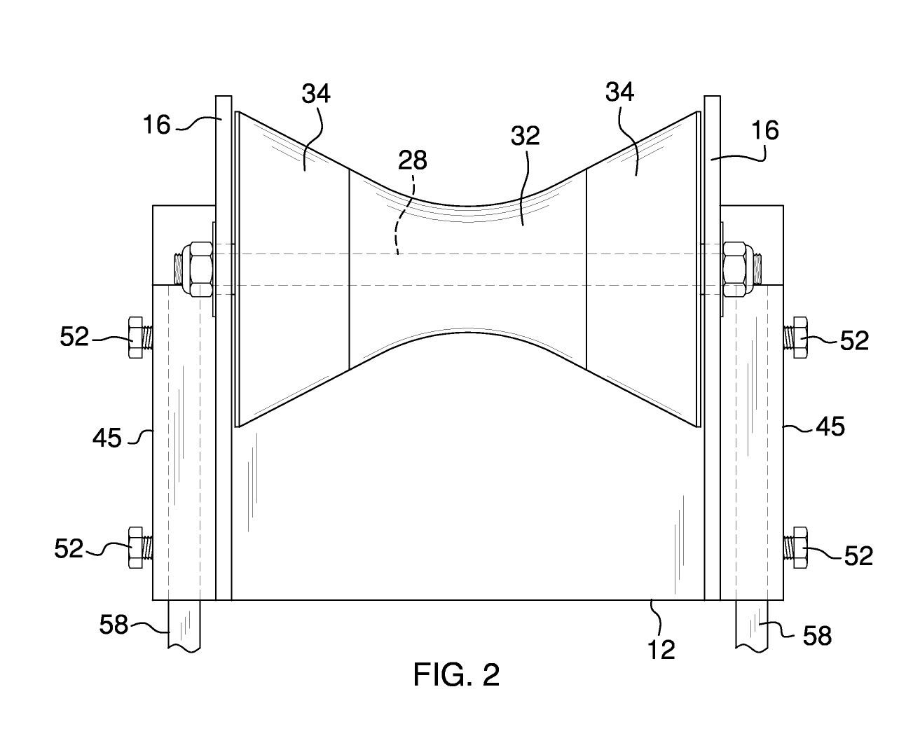

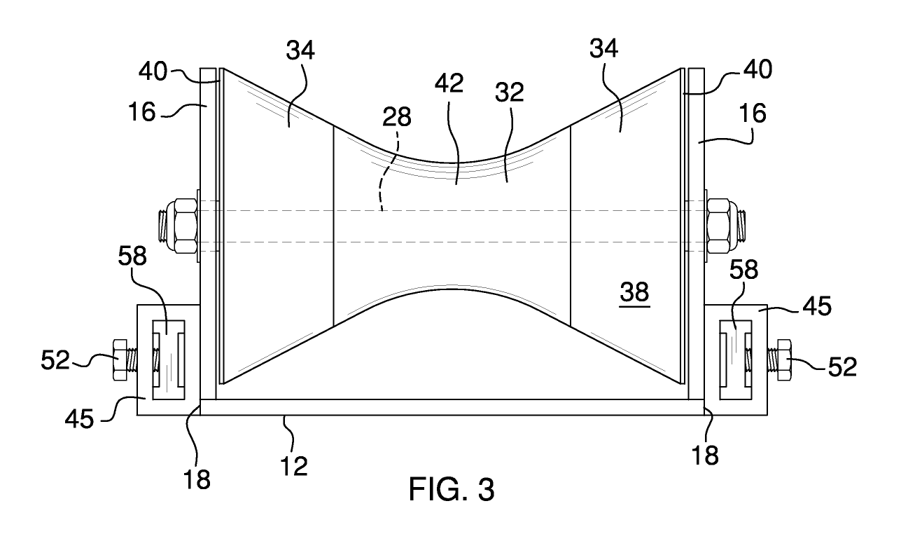

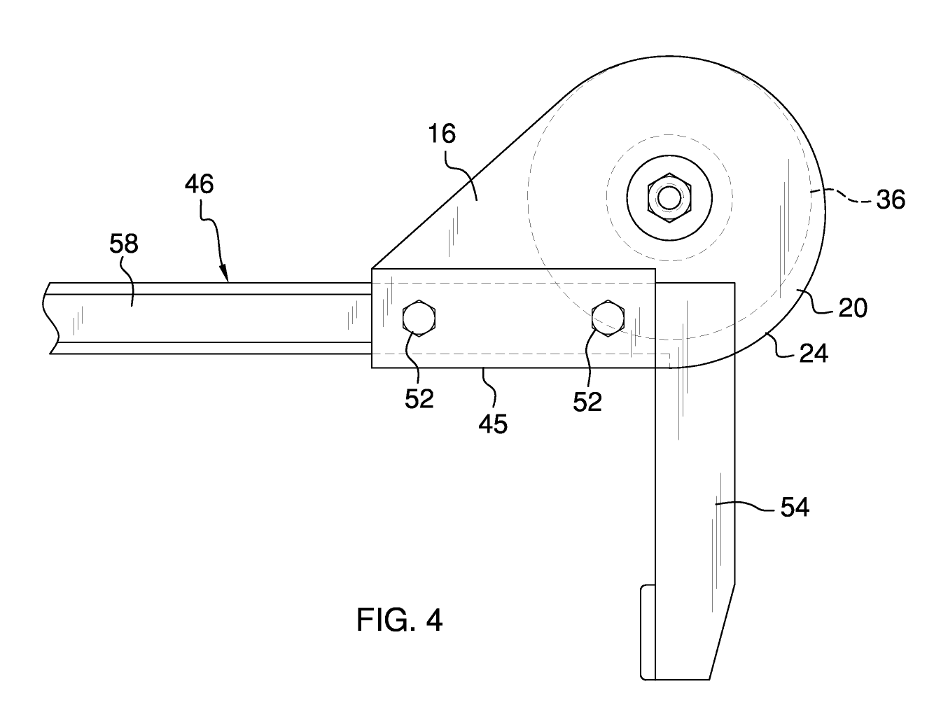

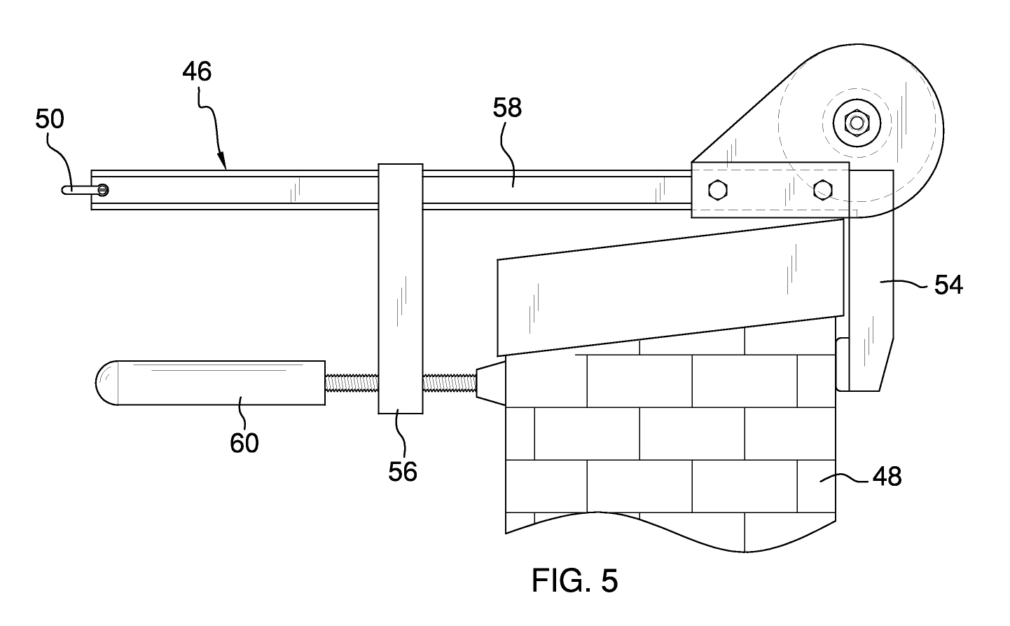

With reference now to the drawings, and in particular to FIGS. 1 through 5 thereof, a new pulley device embodying the principles and concepts of an embodiment of the disclosure and generally designated by the reference numeral 10 will be described.

As best illustrated in FIGS. 1 through 5, the wall mountable pulley device 10 generally comprises a plate 12 having a perimeter edge 14 extending around the plate 12. A pair of side walls 16 is provided. Each of the side walls 16 is coupled to and extends from the plate 12. Each side wall 16 extends along an associated side 18 of the perimeter edge 14 of the plate 12. Each side wall 16 has an offset section 20 extending outwardly beyond an edge 22 of the perimeter wall 14 extending between the side walls 16. Each offset section 20 may have an arcuate outer edge 24. Each of the plate 12 and the side walls 16 may be constructed from stainless steel or like material.

A roller 26 is coupled to and extends between the side walls 16. The roller 26 comprises an axle 28 and a plurality of roller sections 30. The axle 28 extends through each of the roller sections 30. The roller sections 30 comprise a middle section 32 and a pair of outer sections 34. The middle section 32 is selectively separable from the outer sections 34 wherein the roller sections 30 are selectively replaceable. The axle 28 of the roller 26 is coupled to and extends between the offset sections 20 of the side walls 16 wherein the roller 26 is offset from a central longitudinal axis of the plate 12. The arcuate outer edge 24 of each offset section 20 is aligned with an outer diameter of a respective end 36 of the roller 26. An outer surface 38 of the roller 26 is concavely arcuate wherein a diameter of the roller 26 lessens extending inwardly from outer ends 40 of the roller 26 towards a middle 42 of the roller 26. The outer surface 38 of the roller 26 may be constructed of polyurethane or like material.

A pair of mounts 44 is provided. The mounts 44 are coupled to the plate 12 and are spaced apart on the plate 12. Each of the mounts 44 is a tubular sleeve 45. A pair of bar clamps 46 is provided. Each of the bar clamps 46 is coupled to an associated one of the mounts 44 wherein the plate 12 is configured for being coupled to a wall 48 by clamping the bar clamps 46 to the wall 48. Each bar clamp 46 extends through an associated one of the tubular sleeves 45. Each of the bar clamps 46 is selectively separable from the mounts 44 wherein each of the bar clamps 46 is replaceable. This allows bar clamps 46 to be interchangeably attached to the mounts 44 so that a selectable size of bar clamps 46 can be used as needed. The tubular sleeves 45 are parallel such that the bar clamps 46 are parallel extending through the tubular sleeves 45. The shackles 50 may be used to tie back securing ropes. Each of the bar clamps 46 includes a first bar 54, a second bar 56 and a third bar 58. Each first bar 54 is coupled to and extends downwardly from a respective one of the side walls 16. The second bar 56 of each bar clamp 46 is positioned in spaced parallel relationship relative to the respective first bar 54. Each third bar 58 is coupled to and extends between the first 54 and second 56 bars of the associated bar clamp 46. A pair of fasteners 60 is provided. Each fastener 60 may be a screw threadably engaged to and extending into the associated second bar 56. A pair of shackles 50 is provided. Each of the shackles 50 is coupled to an associated one of the bar clamps 46.

A plurality of locking members 52 is provided. Each locking member 52 is coupled to an associated one of the tubular sleeves 45. Each locking member 52 selectively extends into the associated tubular sleeve 45 and engages the associated bar clamp 46 extending through the associated tubular sleeve 45 wherein the associated bar clamp 46 is statically secured to the associated mount 44. Each of the locking members 52 may be a screw threadedly engaged to and extending into the associated tubular sleeve 45.

A distance between each of the mounts 44 may be between approximately 18.0 centimeters and 35.0 centimeters. A length of each of the side walls 16 may be between approximately 15.0 centimeters and 30.0 centimeters. An outer diameter of each offset section 20 may be between approximately 10.0 centimeters and 25.0 centimeters.

In use, as stated above and shown in the Figures, the plate 12 is attached to a wall 48 by securing the bar clamps 46 to the wall 48. Bar clamps 46 of various sizes can be used interchangeably to allow a person to attach the device 10 to walls 48 of varying sizes. A rope, cable or the like is rotatably mounted around the roller 26 and attached to an item to be supported or lifted. The device 10 reduces friction on the rope as the rope is selectively manipulated to manually raise and lower the rope. Additional securing ropes can be attached to the shackles 50 to help retain the device 10 on the wall 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A wall mountable pulley device comprising:
a plate having a perimeter edge extending around said plate;
a pair of side walls, each of said side walls being coupled to and extending from said plate;
a roller coupled to and extending between said side walls; and
a pair of mounts, said mounts being coupled to said plate, said mounts being spaced apart, each of said mounts being configured for coupling a respective bar clamp to said plate wherein said plate is couplable to a wall by clamping the bar clamps to the wall.

2. A wall mountable pulley device comprising:
a plate having a perimeter edge extending around said plate;
a pair of side walls, each of said side walls being coupled to and extending from said plate;
a roller coupled to and extending between said side walls;
a pair of mounts, said mounts being coupled to said plate, said mounts being spaced apart on said plate; and
a pair of bar clamps, each of said bar clamps being coupled to an associated one of said mounts wherein said plate is configured for being coupled to a wall by clamping said bar clamps to the wall.

3. The device of claim 2, further comprising each of said mounts being a tubular sleeve, each said bar clamp extending through an associated one of said tubular sleeves.

4. The device of claim 3, further comprising a plurality of locking members, each locking member being coupled to an associated one of said tubular sleeves, each locking member selectively extending into said associated tubular sleeve and engaging said associated bar clamp extending through said associated tubular sleeve wherein said associated bar clamp is statically secured to said associated mount.

5. The device of claim 4, further comprising each of said locking members being a screw threadedly engaged to and extending into said associated tubular sleeve.

6. The device of claim 3, further comprising said tubular sleeves being parallel such that said bar clamps are parallel extending through said tubular sleeves.

7. The device of claim 2, further comprising each said side wall extending along an associated side of said perimeter edge of said plate, each said side wall having an offset section extending outwardly beyond an edge of said perimeter wall extending between said side walls.

8. The device of claim 7, further comprising said roller being coupled to and extending between said offset sections of said side walls wherein said roller is offset from a central longitudinal axis of said plate.

9. The device of claim 8, further comprising each said offset section having an arcuate outer edge, said arcuate outer edge of each said offset section being aligned with an outer diameter of a respective end of said roller.

10. The device of claim 2, further comprising an outer surface of said roller being concavely arcuate wherein a diameter of said roller lessens extending inwardly from outer ends of said roller towards a middle of said roller.

11. The device of claim 10, further comprising said outer surface of said roller being constructed of polyurethane.

12. The device of claim 10, further comprising said roller comprising an axle and a plurality of roller sections, said axle extending through each of said roller sections, said roller sections comprising a middle section and a pair of outer sections, said middle section being selectively separable from said outer sections wherein said roller sections are selectively replaceable.

13. The device of claim 2, further comprising a pair of shackles, each of said shackles being coupled to an associated one of said bar clamps.

14. The device of claim 2, further comprising each of said bar clamps being selectively separable from said mounts wherein each of said bar clamps is replaceable.

15. A wall mountable pulley device comprising:
a plate having a perimeter edge extending around said plate;
a pair of side walls, each of said side walls being coupled to and extending from said plate, each said side wall extending along an associated side of said perimeter edge of said plate, each said side wall having an offset section extending outwardly beyond an edge of said perimeter wall extending between said side walls, each said offset section having an arcuate outer edge;
a roller coupled to and extending between said side walls, said roller comprising an axle and a plurality of roller sections, said axle extending through each of said roller sections, said roller sections comprising a middle section and a pair of outer sections, said middle section being selectively separable from said outer sections wherein said roller sections are selectively replaceable, said axle of said roller being coupled to and extending between said offset sections of said side walls wherein said roller is offset from a central longitudinal axis of said plate, said arcuate outer edge of each said offset section being aligned with an outer diameter of a respective end of said roller;
an outer surface of said roller being concavely arcuate wherein a diameter of said roller lessens extending inwardly from outer ends of said roller towards a middle of said roller, said outer surface of said roller being constructed of polyurethane;
a pair of mounts, said mounts being coupled to said plate, said mounts being spaced apart on said plate, each of said mounts being a tubular sleeve;
a pair of bar clamps, each of said bar clamps being coupled to an associated one of said mounts wherein said plate is configured for being coupled to a wall by clamping said bar clamps to the wall, each said bar clamp extending through an associated one of said tubular sleeves, each of said bar clamps being selectively separable from said mounts wherein each of said bar clamps is replaceable, said tubular sleeves being parallel such that said bar clamps are parallel extending through said tubular sleeves;
a plurality of locking members, each locking member being coupled to an associated one of said tubular sleeves, each locking member selectively extending into said associated tubular sleeve and engaging said associated bar clamp extending through said associated tubular sleeve wherein said associated bar clamp is statically secured to said associated mount, each of said locking members being a screw threadedly engaged to and extending into said associated tubular sleeve; and
a pair of shackles, each of said shackles being coupled to an associated one of said bar clamps.
